(19) United States
(12) Patent Application Publication
(10) Pub. No.: US 2010/0044892 A1
(43) Pub. Date: Feb. 25, 2010

(54) Separating Device For Sintering Shoes

(75) Inventor: Jean-Pierre Pages, Sernhac (FR)

Correspondence Address: Nixon Peabody LLP, P.O. Box 60610, Palo Alto, CA, 94306, US

(73) Assignee: AREVA INC, PARIS (FR)

(21) Appl. No.: 12/160,415

(22) PCT Filed: Jan. 8, 2007
(86) PCT No.: PCT/EP07/50150

§ 371 Date: Jul. 9, 2008

(30) Foreign Application Priority Data
Jan. 10, 2006 (FR) 06/50091

(51) Int. Cl. G21C 21/02; B65G 35/00; B65G 43/08

(52) U.S. Cl. 264/5; 198/463.1; 198/464.2

(57) ABSTRACT

Device comprising means of separating at least two sintering shoes for transporting nuclear fuel pellets capable of moving according to a first axis (X) and of which two end faces are in contact with one another, wherein said separating means are capable of moving at least one of the two sintering shoes close to said end faces in contact, according to a second vertical axis (Y) substantially orthogonal to the first axis (X).

### CROSS REFERENCE TO RELATED APPLICATIONS OR PRIORITY CLAIM

This application is a national phase of International Application No. PCT/EP2007/050150, entitled “SEPARATING DEVICE FOR SINTERING SHOES”, which was filed on Jun. 8, 2007, and which claims priority of French Patent Application No. 06 50091, filed Jan. 10, 2006.

### TECHNICAL FIELD AND PRIOR ART

This invention concerns a separating device for sintering shoes designed to transport nuclear fuel pellets, especially MOX pellets (mixture of oxide plutonium and uranium oxide) inside a sintering furnace.

The nuclear fuel rods contain pellets formed from nuclear fuel powder, for example of the MOX type, that are pressed then sintered.

The powder is pressed with a press comprising several press dies, wherein the pellets are then carefully placed in sintering boats, which are in turn placed on the transport sintering shoes. These sintering shoes are placed behind each other to form a train of sintering shoes and are then moved into a sintering furnace.

The MOX pellets are sintered between 1650° C. and 1750° C. in a reducing atmosphere for several hours. Sintering shoes capable of supporting such temperatures are, for example made from molybdenum or molybdenum alloy.

The sintering shoes are substantially rectangular in shape; consequently when the train of sintering shoes is moved, a front face of a sintering shoe is in contact with a rear face of the sintering shoe in front of it.

The sintering shoes are moved inside the furnace by a push rod with a travel distance equal to the length of a sintering shoe.

When the pellets transported by a sintering shoe have completed their sintering period, the sintering shoe, which forms the first sintering shoe of the train, is extracted from the furnace by means of a lateral push rod.

The extracted sintering shoe is moved into a chamber, and the sintered pellets are unloaded then reloaded with unsintered pellets and reintroduced into the furnace, to form the last sintering shoe of the sintering shoe train.

However, a phenomenon of bonding or adhesion between sintering shoes in contact with one another may be observed. This bonding is partially due to the diffusion of the molybdenum between a front face of a sintering shoe and a rear face of a sintering shoe in front of it, and to the discharge of combustion residues.

The joining of the two sintering shoes thus prevents a sintering shoe being extracted by the actuator. Indeed, when the actuator pushes a sintering shoe that is bonded to a sintering shoe in front or behind it, the two sintering shoes are moved together, which prevents the sintering shoe from being extracted.

Consequently one purpose of the invention is to propose a device which permits the extraction of a determined sintering shoe at the end of the sintering phase.

### DESCRIPTION OF THE INVENTION

The purpose mentioned above is achieved by a device for separating sintering shoes which permits two bonded sintering shoes to be separated.

In other terms, the device according to the invention comprises means of soliciting, especially mechanically, the bonded link between two sintering shoes and of breaking it.

Indeed, the bonded link is mechanically weak; consequently a mechanical stress of low intensity is sufficient to separate the sintering shoes without damaging them.

The sintering shoes move in a plane that is substantially horizontal, wherein the separating device according to the invention applies an effort according to a substantially vertical direction to at least one of the sintering shoes, especially in the bonding zone.

The subject-matter of the present invention is mainly a device comprising means of separating at least two sintering shoes for transporting nuclear fuel pellets capable of moving according to a first axis and of which the two end faces are in contact with one another, wherein said separating means are able to move at least one of the two sintering shoes, close to said end faces in contact, according to a second vertical axis that is substantially orthogonal to the first axis.

According to a first and a second embodiment, the vertical effort is exerted by an eccentric from the bottom towards the top.

The separating means may comprise at least one eccentric capable of coming into contact with a lower surface of at least one sintering shoe to raise it along an axis that is substantially orthogonal to a movement surface of the sintering shoes.

The contact between the at least one eccentric and the least one sintering shoe is made, for example, at the contact point between the ends of the two sintering shoes.

The contact between the at least one eccentric and the at least one sintering shoe may also be made on one of the sintering shoes close to the contact point between the two sintering shoes.

Advantageously, the separating device according to the invention comprises means of limiting the movement of at least one end of a sintering shoe along the raising axis.

Said end of which the movement is limited, may then be on the opposite side to the end raised.

In a first embodiment, the means of limiting the movement comprise stops attached to the lateral walls of the furnace.

These stops may be formed by strips having a recess on their lower face opposite the sintering shoes to permit them to be raised.

The recess, for example, may be in the form of an inverted V.

Advantageously, the device according to the invention comprises means of adjusting the distance between the strips and the sintering shoes, wherein said means are formed by eccentrics mounted in slots in the strips.

In a second embodiment, the means of limiting the movement along the axis that is orthogonal to the plane of movement of the sintering shoes, simultaneously limit the movement of the end of one of the two sintering shoes designed to be raised, wherein said end is remote from the part to be raised, and one end of the other sintering shoe of the side where there is contact between the two sintering shoes.

The means of limiting the movement along the axis that is orthogonal to the plane of movement of the sintering shoes comprise, for example, eccentrics that move close to an upper surface of the sintering shoes to limit the distance they are raised with respect to the part that is to be raised.

The eccentrics for limiting the movement along the axis that is orthogonal to the plane of movement of the sintering shoes, are synchronised with the rotational movement of the eccentrics so that the eccentrics for limiting the movement and the eccentrics for raising simultaneously move close to the upper and lower surfaces of the sintering shoes respectively.

Advantageously, all of the eccentrics are driven by single drive means and are connected in rotation by a chain.

In a third embodiment, the means of separating are capable of exerting an impact onto at least one sintering shoe close to the face that is bonded to the other sintering shoe according to a downwards vertical direction.

The means of separating may comprise arms to hold the sintering shoe laterally and transmit the impact to the sintering shoe, wherein said arms are applied to the first sintering shoe by an actuator.

In one embodiment, the impact is applied by a mass which falls due to gravity.

Advantageously, the mass is freed when a predetermined stress is applied to the first sintering shoe by arms designed to come into contact with the sintering shoe.

The device according to the third embodiment may comprise means of suspending the mass and means of removing said suspension means.

The removal means are, for example controlled by a sensor which detects that the predetermined stress has been reached.

In one embodiment, the suspension means comprise a square that can move in rotation around a fixed axis of a chassis of the separating device, wherein said square comprises a support leg onto which the mass comes into contact, and an actuating leg which causes the removal of the support leg.

The sensor may then comprise a wire that may engage with the actuating leg to cause the square to tilt and the support leg to be removed.

The arms are advantageously fixed by an end opposite that designed to come into contact with the first sintering shoe, a cross-bar connected to the actuator by a transmission arm and by a rod along which the mass may slide.

The transmission arm, in one embodiment, comprises an outer sleeve fixed to one end of the actuator, an inner sleeve that can slide inside the outer sleeve, a guiding shaft that can slide inside the inner sleeve and elastic means mounted inside the outer sleeve, between the outer sleeve and the inner sleeve.

The mass, for example, may rest on a square fixed to the outer sleeve.

Advantageously, the device according to the third embodiment also comprises an actuator rest position sensor. This sensor and/or the sensor which detects if the predetermined stress has been reached may be of the cam type comprising a cam surface attached to the outer sleeve and an element that can move along the cam surface.

Advantageously, the arms comprise at their end designed to come into contact with the first sintering shoe, a face forming a vertical stop and a lateral face forming a lateral stop.

The ends of the arms may be chamfered.

In one specific example, at rest the arms have a retracted position so that the distance separating the ends of the arms is less than that separating the lateral ends of a sintering shoe.

Another purpose of the invention is an installation for sintering nuclear fuel pellets comprising a sintering furnace inside which sintering shoes are designed to move in a column, carrying sintering boats and a separating device according to the invention, wherein said separating device is located downstream of the furnace in the direction of movement of the sintering shoes.

Another subject-matter of the invention is a manufacturing process for nuclear fuel pellets comprising the following steps:

a) the determination of the presence of at least one sintering shoe,

b) the application of a mechanical stress to at least one sintering shoe according to a substantially vertical direction.

In step a), the presence of a sintering shoe is advantageously determined by the detection of a sintering shoe downstream that is ready to be evacuated.

In step a), it may be provided that the sintering shoes stop moving.

In step b), the mechanical stress may be applied to the two sintering shoes simultaneously or to just one of the two sintering shoes.

### BRIEF DESCRIPTION OF THE DRAWINGS

The invention will be more clearly understood upon reading the following description and the appended drawings, in which:

FIG. 1 is a longitudinal cross sectional view of a first embodiment of a device according to the invention,

FIG. 2 is a cross sectional view according to the cross sectional plane B-B of FIG. 1,

FIG. 3A is a transversal cross sectional view of FIG. 1,

FIG. 3B is a view of an outside detail of the device according to FIG. 1,

FIG. 4 is a cross sectional view according to the cross sectional plane C-C of FIG. 1,

FIG. 5 is a detailed view of FIG. 1,

FIG. 6 is a top view of a second embodiment of a device according to the invention,

FIG. 7 is a cross sectional view according to the plane E-E of FIG. 6,

FIG. 8 is a side view of the device of FIG. 6 according to the arrow F,

FIG. 9 is a cross sectional view according to the plane A-A of FIG. 8,

FIG. 10 is a semi-cross sectional view according to the plane C-C of FIG. 8,

FIG. 11 is a partial cross sectional view according to the plane B-B of FIG. 8,

FIG. 12 is a detailed view of FIG. 11 with an adjustment tool,

FIG. 13 is a detailed view of a cross section according to the plane G-G of FIG. 6,

FIG. 14 is a cross sectional view of a third embodiment of a device according to the invention according to a plane that is orthogonal to the movement surface of the sintering shoes,

FIG. 15 is a cross sectional view according to the plane A-A of FIG. 14,

FIG. 16 is a top view of the device of FIG. 14,

FIG. 17 is a detailed view of FIG. 15 in a rest position,

FIG. 18 is a detailed view of FIG. 14 in a rest position.

### DETAILED DESCRIPTION OF SPECIFIC EMBODIMENTS

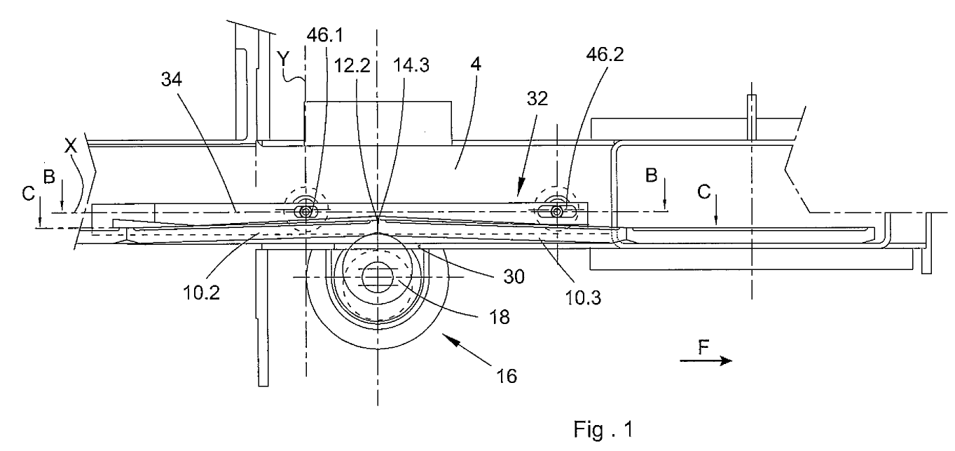

FIGS. 1 to 5 show a first embodiment of a device according to the invention; this device is placed at the outlet of the sintering furnace upstream of the extraction of the sintering shoes at the end of the sintering phase.

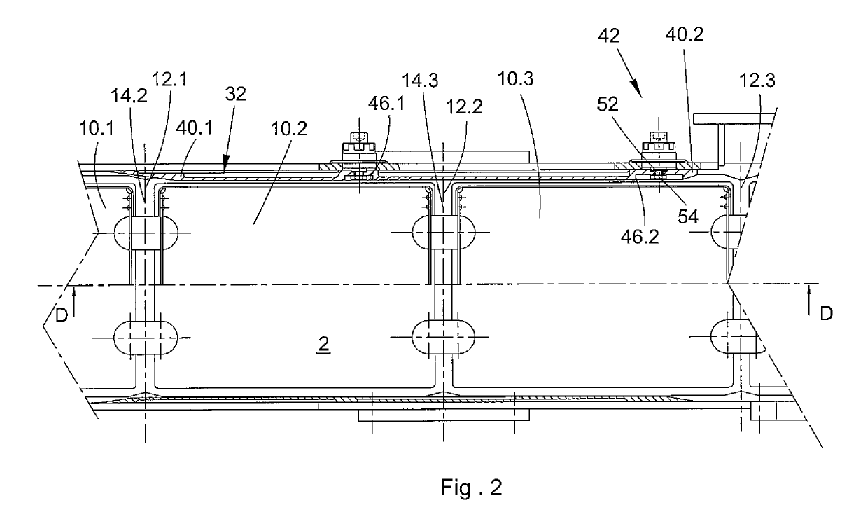

FIGS. 1 and 2 show a tunnel 2 with an X axis, defined by lateral walls 4, and upper and lower walls. The lower wall 8 forms a substantially horizontal plane of movement on which a train of sintering shoes 10.1, 10.2, 10.3 moves according to the X axis in the direction of the arrow F. The sintering shoes 10.1, 10.2, 10.3 are positioned one after the other and are respectively in contact by their front face 12.1, 12.2, 12.3 against the rear faces 14.2, 14.3 of the preceding sintering shoes.

The sintering shoes have, viewed from above, a substantially rectangular form and the contact between the sintering shoes is made according to planes which are orthogonal to the X axis. We will call the front and rear faces in contact with one another and possibly bonded to one another, the interface I.

Consequently the bonding between the sintering shoes may occur along the entire contact plane defined by the interface; the separating device according to the invention may exert a bond-breaking stress along the entire bonding plane.

According to the first embodiment, the bond-breaking device comprises means 16 (FIG. 1) capable of selectively raising, by applying an effort according to a substantially vertical upwards direction, the interface between two sintering shoes according to a Y axis that is substantially orthogonal to the plane of movement of the sintering shoes. The interface is raised in relation to the other parts of the sintering shoes which are held substantially immobile according to the Y axis.

The raising means 16 comprise a cam shaft equipped with at least one eccentric 18, advantageously two eccentrics (FIG. 4) attached to a shaft 20 that is mobile in rotation around a Z axis orthogonal to the X and Y axes and positioned below the lower wall 8 of the tunnel 2.

More precisely, the shaft 20 is mounted in a base 24 of a structure surrounding the tunnel.

The base 24 comprises lateral posts 26.1, 26.2 of which one 26.1 comprises a cavity in which one end 28.1 of the shaft 20 is housed; the other post 26.2 comprises a through passage inside which a second end 28.2 of the shaft 20 is mounted in rotation by means of bearings, for example ball bearings. Drive means (not shown) are provided to rotate the shaft 20.

The distance between the edge of the eccentric 18 and the axis of rotation Z varies between a minimum value at most equal to the distance separating the Z axis of the shaft 20 and the lower wall 8 and a maximum value determined to exert a stress that is sufficient to ensure the separation of the front and rear faces of the sintering shoes.

As may be seen in FIG. 4, the lower wall 8 comprises openings 30 for the passage of the eccentrics 18, wherein the latter have a substantially rectangular form and are made opposite the eccentrics 18.

Advantageously, the device comprises means 32 (FIGS. 1 and 5) of limiting the movement of the respective front 12.2 and rear 14.3 faces of the following 10.2 and preceding 10.3 sintering shoes according to the axis Y controlled by the raising means 16.

The means 32 comprise, advantageously, two vertical stops respectively attached to each of the lateral walls 4 protruding from them towards the inside and at a determined distance from the lower wall 8 according to the Y axis.

These vertical stops are, for example formed by strips 34 extending according to the X axis substantially over a length equal to two sintering shoes on either side of the position of the eccentrics 18.

These strips 34 comprise a lower face 36 opposite the sintering shoes, having a recess 38 (FIGS. 1 and 5) made between one longitudinal front end 40.2 and one longitudinal rear end 40.1 of each strip.

The recess 38 is substantially, viewed from the side, in the form of an inverted V. The strips 34 are attached to lateral walls 4 at a determined distance from the lower wall 8, so that the distance d1 separating the bottom of the recess 38 from the upper part of the sintering shoe when the latter is resting on the lower wall 8 is greater than the maximum movement of the sintering shoe interface created by the eccentrics 18.

Furthermore, the distance d2 separating the ends 40.1 and 40.2 of the strips from the lower wall 8 is slightly greater than the thickness of a sintering shoe. Consequently, the movement of the ends 40.1 and 40.2 of the sintering shoes according to the Y axis is limited.

The distance d2 takes account of warping that may occur on the sintering shoes when they are used at high temperatures; d2 is for example equal to 23 mm for a sintering shoe of a thickness of 18 mm.

The strips 34 limit the movement according to the Y axis of the ends of the two sintering shoes 10.2, 10.3 remote from the interface I, which improves the efficiency of the bond-breaking.

In the example shown, the front end 40.2 of the lower face 36 of each strip 34 comprises a part 44 that is substantially parallel to the lower wall 8 so as to recentre the sintering shoes according to the axis, and the rear end 40.1 of the lower face 36 comprises a recess 45 that is substantially in the form of an inverted half-V, thus allowing for the warp of the sintering shoes.

In the example shown, the strips are fitted on the lateral walls 4, but it is possible for them to be made in one piece with the lateral walls.

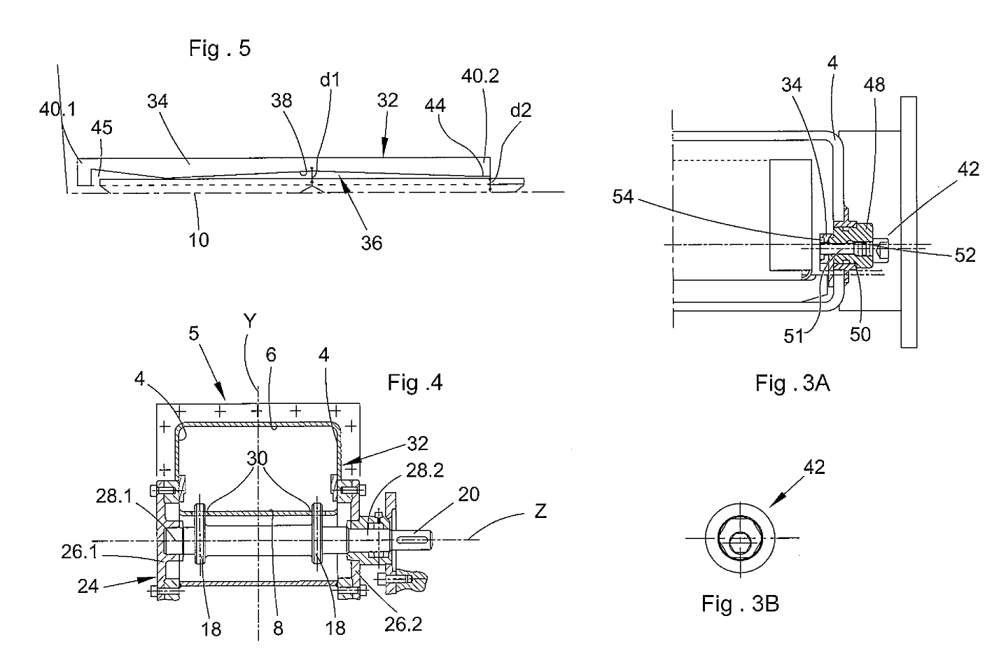

In the embodiment shown and advantageously, the device also comprises means 42 (FIGS. 3a and 3b) of adjusting the position according to the Y axis of the stops 32, thus permitting the position of the stops to be adapted in function of the thickness of the sintering shoe.

The device according to the invention may thus be used for different types of sintering shoes.

The adjustment means 42 positioned at the ends 40.1 and 40.2 of the strips are associated to means of attaching the strip to the lateral wall 4. As a variant, in the case of a device designed for a single type of sintering shoes, a simple attachment may be provided, for example using screws or bolts.

In the example shown, the strips comprise ports 46.1, 46.2 (FIGS. 1 and 2) which pass through the front and rear ends that are formed by axial slots permitting the axial position of the strips 34 to be adjusted along the X axis relative to the lateral walls 4.

There are two adjustment means 42, in the example shown, for each strip 34. We will now describe one of them.

One means of adjustment comprises a sheath 48 mounted in rotation in an orifice 50 of the lateral wall 4 of the tunnel. The sheath 48 comprises an off centre bore 52 opening into the tunnel; a rod 51 opening into the slot 46.1 is mounted inside the bore 52. The rod 51 is equipped at its end which protrudes into the tunnel with a head 54 with a diameter that is greater than the width of the slot 46.1 to hold the strip 34 against the wall. The strip 34 is then held between the head 54 and the wall 4.

The rod 51 comprises at its end situated the outside the tunnel means of modifying its angular position. In the example shown, the rod comprises a hollow hexagonal drive head; however a projecting head or cruciform type head or any other form could be used.

The sheath 48 is mounted in rotation imperviously inside the structure, to maintain a determined pressure inside the tunnel.

We will now explain how such a device operates.

The train of sintering shoes 10 moves inside the tunnel 2 on the lower wall 8 according to the arrow F.

The device also comprises a sintering shoe presence detector (not shown); the detection of a sintering shoe causes the actuation of the separating device.

When the interface I is opposite the openings 30, the movement of the sintering shoes is suspended. The shaft 20 is rotated and the eccentric part of the eccentrics raises the interface I; the movement of the ends 14.2, 12.3 of the sintering shoes 10.2, 10.3 is limited according to the Y axis by the strips 34.

The upper faces of the raised sintering shoes respectively follow the angles of the V-shaped recess 38. The raising thus causes the breakage of the bonded link that may exist between the front 12.2 and rear 14.3 faces, thus freeing the sintering shoes 10.2 and 10.3.

In one embodiment, the sintering shoe has a width of around 210 mm and transports a sintering boat of around 188 mm in width; the eccentrics operate on a width of around 160 mm.

It is also possible to provide continuous rotation of the shaft 20 by synchronising the drive means with the speed of movement of the sintering shoes, so that the end of the eccentric the furthest away from the axis of rotation protrudes from the associated opening 30 when an interface I is opposite said openings 30. The circumference of the eccentric would then be chosen substantially equal to the length according to the X axis of a sintering shoe so that one rotation tour of the eccentric 18 corresponds to the movement of one sintering shoe.

The sintering shoe to be extracted is then extracted using suitable means.

With this device, all of the interfaces between the sintering shoes are raised, even if there is no bonding present.

In the embodiment shown, the device comprises two eccentrics 18, however a single central eccentric more than two eccentrics positioned across the width of the lower wall 8 could be provided.

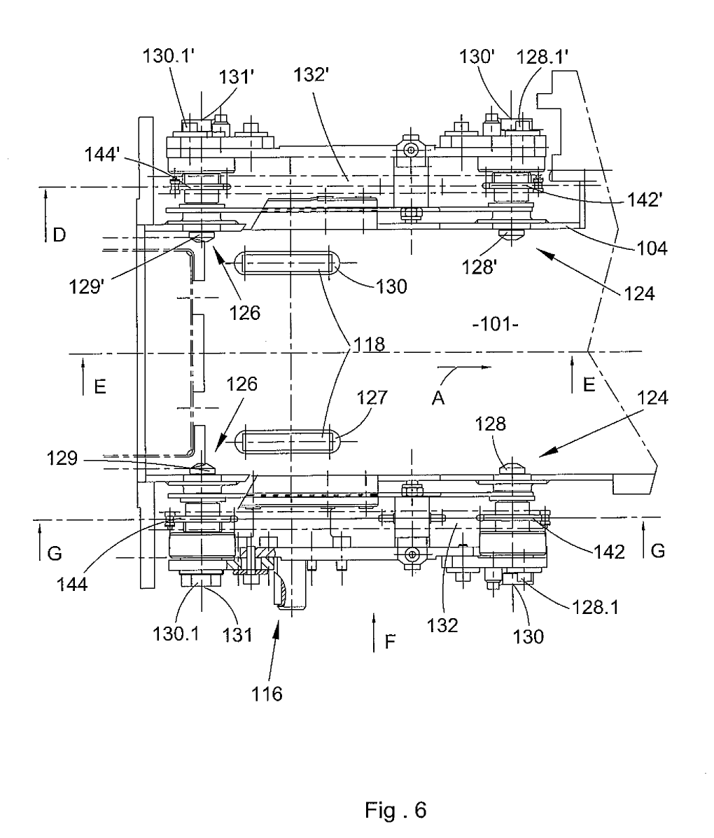

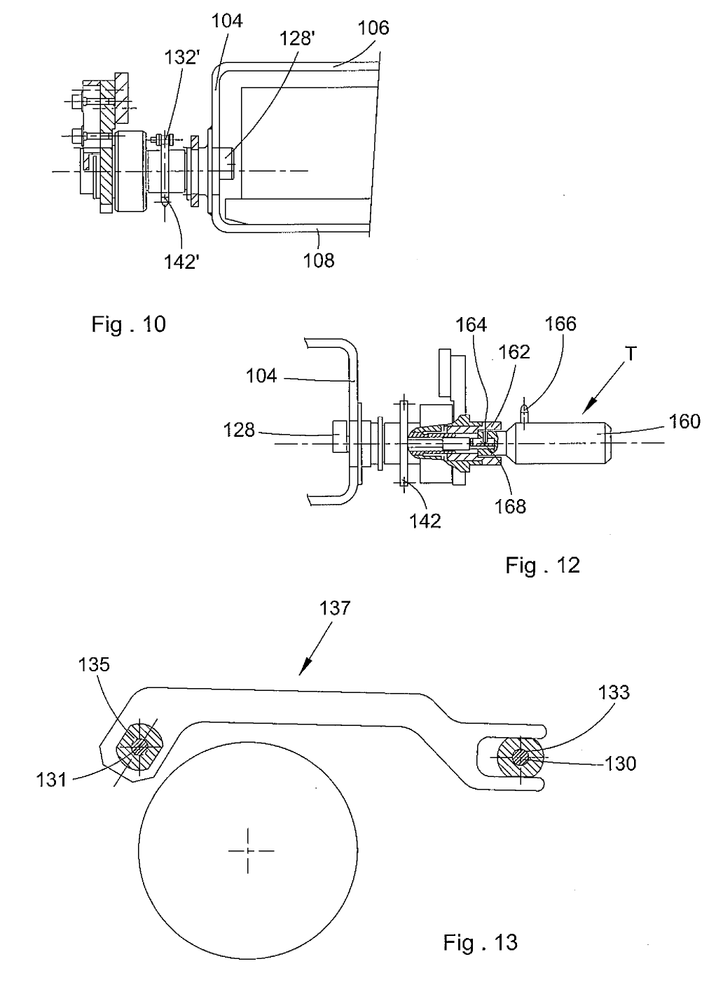

FIGS. 6 to 13 show a second embodiment of a separating device for sintering shoes according to the invention also comprising a cam shaft positioned under the lower wall of the tunnel; however in this case, the eccentrics do not act on the interface but close to it on just one of the two sintering shoes.

FIG. 6 shows the device according to the second embodiment, in a top view, positioned in an outlet channel 101 of a sintering furnace.

The outlet channel is formed by a tunnel 102 defined by lateral walls 104, wherein an upper and a lower wall 108 form a movement surface for a train of sintering shoes 110.

As in the first embodiment, the separating device exerts a vertical effort, and for this purpose it comprises a cam shaft 116 positioned below the lower wall 108 and equipped with eccentrics 118 designed to protrude above the lower wall 108 through openings 127 formed in it.

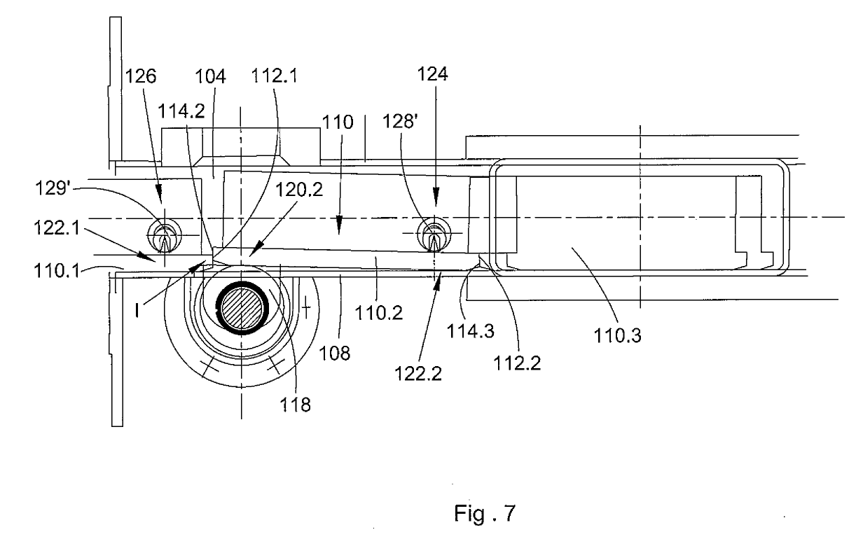

FIG. 7 shows a train of sintering shoes comprising sintering shoes 110.1, 110.2 and 110.3. The front faces 112.1, 112.2 of the sintering shoes 110.1, 110.2 respectively are in contact with the rear faces 114.2, 114.3 of the sintering shoes 110.2, 110.3 respectively.

The device may also comprise means of detecting (not shown) the interface I between two sintering shoes, such as a sensor.

The device also comprises a sintering shoe presence detector (not shown); the detection of a sintering shoe causes the actuation of the separating device.

The device is provided in this embodiment so that the eccentrics come into contact with part 120.2 of the sintering shoe 110.2 positioned close to the interface I and not directly with the interface I. This part 120.2 is positioned in the example shown in FIG. 7 downstream of the interface I in the direction of movement of the train of sintering shoe shown by the arrow A, however it may be provided that the eccentrics come into contact with part 122.1 of the sintering shoe 110.1 positioned upstream of the interface I.

The action of the eccentrics on the part 120.2 causes the raising of the rear end 112.2 of the corresponding sintering shoe.

Advantageously, the device according to the invention comprises means 124 capable of limiting the movement according to the Y direction, of the end 122.2 of the sintering shoe 110.1 remote from the part 120.2 designed to be raised.

The device also comprises means 126 of limiting the movement of the part 122.1 of the preceding sintering shoe 110.1 according to the Y axis, which may be bonded to the sintering shoe 110.2. Consequently, by exerting an upwards thrust effort on the part 122.1 of a sintering shoe 110.2 and by maintaining the other sintering shoe 110.1 in position according to the Y axis, the bond-breaking of the two sintering shoes 110.1, 110.2 is improved and accelerated.

The means 124, 126 are each formed by two eccentrics 128, 128′, 129, 129′ respectively attached in rotation to a shaft 130, 130′, 131, 131′ and each mounted in rotation in a lateral wall 104 at a determined distance from the lower wall, so that the minimum distance between the edge of the eccentric and the lower wall is slightly greater than the thickness of the sintering shoe, to avoid a contact between the edge of the eccentric and the sintering shoe, and a risk of jamming.

The sintering shoes have a thickness, for example of 18 mm. Furthermore, the sintering shoe may, due to its use at high temperature, be distorted. An additional clearance is therefore provided of 5 mm to take this warping into account. Consequently a distance of 23 mm may be provided between the edge of the eccentric and the lower wall to ensure the correct operation of the separating device.

The shafts 130, 131 are mounted in bearings 133, 135, respectively passing through the lateral walls. The shafts 130′ and 131′ are also mounted in bearings (not shown).

The bearings are held immobile in rotation with respect to the lateral wall that they pass through. In the example shown, an “anti-rotation” key 137 connects the bearings 133, 135. This may be seen in FIG. 13, it comprises orifices at its ends which correspond to the outside contours of the bearings, wherein these contours have at least one flat. A similar key connects in rotation the bearings of the shafts 130′ and 131′.

The eccentrics 128, 128′ and 129, 129′ are mounted substantially opposite in the left hand and right hand walls, considering the direction of movement of the sintering shoes according to the arrow A.

Means are provided to synchronise the rotation of the eccentrics 118 and the eccentrics 128, 128′, 129, 129′, so that the eccentric part of all the eccentrics is orientated towards the sintering shoes simultaneously.

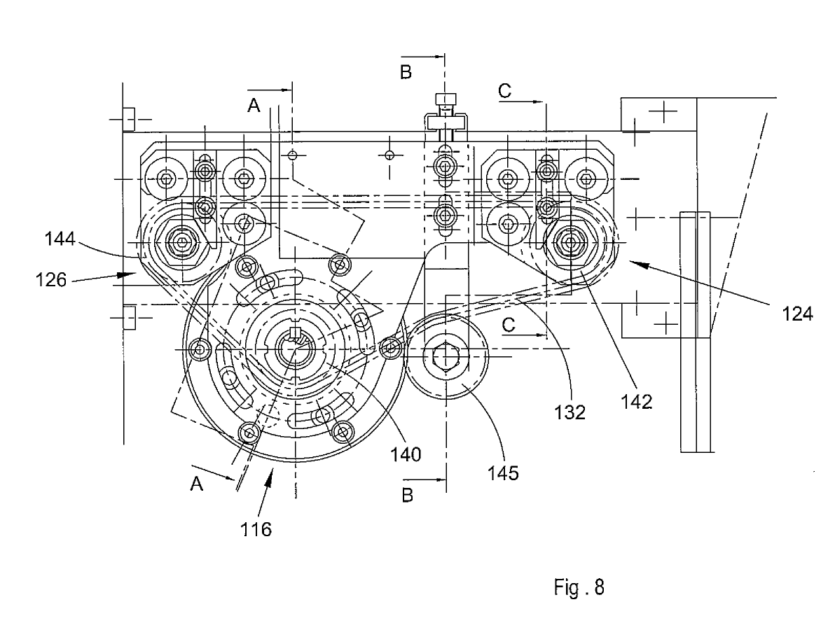

Advantageously, the eccentrics 118, 128, 128′ and 129, 129′ are driven by single drive means (not shown) by means of a chain 132 that may be seen in FIG. 8, for example of the roller chain type; a toothed belt may also be suitable.

Advantageously, the shafts 130, 130′, 131, 131′ comprise an index 128.1, 128.1′, 131.1, 131.1′ for identifying the angular position of the eccentrics 128, 128′, 129, 129′. This index is mounted on a longitudinal end of the shaft 130, 130′, 131, 131′ opposite that bearing the eccentric 128, 128′, 129, 129′.

The chain is mounted around gear wheels 140, 140′, 142, 142′, 144, 144′ respectively fixed to the shaft 117 bearing the eccentrics 118 and the shafts 130, 130′, 131, 131′ of the eccentrics 128, 128′, 129, 129′.

A tensioner 145 is provided to keep the chain 132 taut, for example a ball tensioner.

The number of teeth of the gear wheels 140, 142, 144 and 140′, 142′, 144′ is determined to synchronise the movement of the eccentrics 118, 128, 128′, 129, 129′.

The synchronisation is then carried out simply, as the position of the eccentrics simply needs to be adjusted correctly when the device is mounted; the relative movement of the eccentrics is then controlled by the chain 132.

The device comprises a chain 132 on a right hand side in the direction of movement of the sintering shoes shown by the arrow A, to drive the eccentrics 128, 129 on the right hand lateral wall and a chain 132′ on a left hand side to drive the eccentrics 128′, 129′ on the left hand lateral wall.

The actuation means drive the shaft 117 directly by one end 134, however it may be provided that it drives directly one or the other of the means 124, 126; the shaft 117 would then be driven by the chain 132.

It may also be provided that the drive means only drive the chain 132 directly.

The gear wheel 140′ is mounted fixed in rotation on one end 136 of the shaft 117 opposite the end 134 connected to the actuation means.

The gear wheels 142, 142′, 144, 144′ are fixed to the shafts 130, 130′, 131, 131′ respectively by means of a drive sheath 146, 146′, 148, 148′.

In the following description, we will describe the pinion 142, sheath 146 and shaft 130 assembly, as the other gear wheel-sheath-shaft assemblies are substantially identical.

The gear wheel 142 is equipped with a crown 150 with teeth on its outside contour that is attached by its inside contour to a sleeve 152, advantageously made in one piece with the crown 150.

The shaft 130 is fixed in rotation with the sleeve 152 by means of a drive sheath 154, fixed in rotation by its outside edge with the sleeve 152 and by its inside edge with the shaft 130.

The sheath 154 comprises, for example an octagonal recess on its inside edge, and a decagonal recess on its outside edge that can engage with matching recesses on the inside edge of the sleeve 150 and in the shaft 130.

A nut 141 is mounted on the shaft on contact with one end of the sheath 154 to hold it in position longitudinally on the shaft 130.

FIG. 12 shows a tool T for adjusting the position of the eccentrics 128, 128′, 129, 129′.

The tool T comprises a handling sleeve 160 and a collar 162. Advantageously, the handling sleeve 160 and the collar 162 are independent.

The sleeve 160 comprises a first element 164 to attach the shaft 130 and the sleeve 160 in rotation, formed in the example shown by a pin fixed into a longitudinal end of the sleeve 160 perpendicularly to the axis of the sleeve. The sleeve 160 comprises a second element 166 forming the identification element of the pin 164, formed by a second pin mounted in the sleeve 160, orientated identically to the first pin 164. Consequently, the angular position of the second pin 166 is that of the first pin. Consequently when the first pin is mounted in the shaft 130, the operator using the tool T knows the angular position of the first pin 164 opposite the second pin 166.

We will now describe the adjustment of the angular position of the eccentrics using the tool T.

The index 128.1 and the end nut 141 on the shaft 130 are removed.

The drive chain may also be removed, however this is not necessary.

The first pin 164 borne by the sleeve 160 is positioned in a recess 168 in the end of the shaft 130 bearing the nut 141. The recess 168 is orthogonal to the axis of the shaft 130. The recess 168 is, for example, formed by a flat.

The collar 162 is then screwed into the sheath 154. The operator then removes the sheath 154 axially outwards, which permits it to be turned around its axis, and the eccentric 128 may then be offset angularly in a first direction of rotation or in a second direction of rotation, by using the angular offsets in the form of decagons and octagons of the sheath 154. This adjustment is made while ensuring the position of the other eccentric axes 128.

It is therefore possible to optimise the angular positions of each eccentric 128, 128′, 129, 129′, so that they operate together with the same orientation.

When the position is obtained, the operator reintroduces the sheath 154 into the bearing 150, and unscrews the collar 164, and finally removes the sleeve 160.

The nut 141 is fitted again as well as the index 128.1, and the chain if it has been removed.

This adjustment is made for each of the other eccentrics 128′, 129′, 129′.

We will now describe the operation of this separating device.

Upon arrival of an interface, the movement of the sintering shoes is suspended and the actuation is activated.

This causes the rotation of the shaft 117 bearing the eccentrics 118 and the gear wheels 142, 142′, 144, 144′, thus rotating the eccentrics 128, 128′, 129, 129′ respectively.

The eccentrics 118 then cause the raising of the rear part 120.2 of the sintering shoe 110.2, while the eccentrics 128, 128′ limit the movement of the front part 122.2 of the sintering shoe 110.2, and the eccentrics 129, 129′, limit the movement of the front part 122.1 of the sintering shoe 110.1.

The bond between the front 112.1 and rear 114.2 faces of the sintering shoes 110.1, 110.2 respectively is thus broken; the sintering shoe 110.2 may be removed.

Means of detecting the separation of the sintering shoes are advantageously provided, for example they are formed by a magnetic proximity sensor positioned at the end of a sintering shoe evacuation channel.

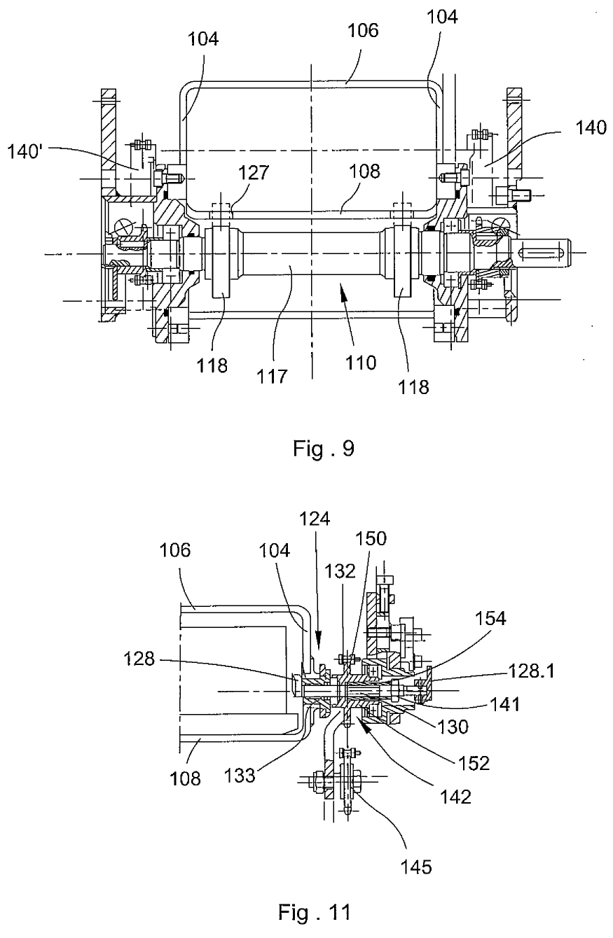

A single eccentric 118 may be provided, advantageously with a greater width than that of the eccentrics shown in FIG. 6 or 9, to improve the stability of the sintering shoes, however they cause greater wear and require more powerful actuators.

Furthermore, the use of two eccentrics ensures certain stability of the sintering shoes when they are warped due to deformation.

At least two means for driving the eccentrics may be provided, one for the eccentrics 118 and the other for the eccentrics 128, 128′, 129, 129′ or even distinct drive means for each of the pairs of eccentrics or for each eccentric. Means of synchronising the different drive means would be required in this case.

It may also be envisaged to provide a separation of the sintering shoes simultaneously with their movement, for example by slowing down their movement.

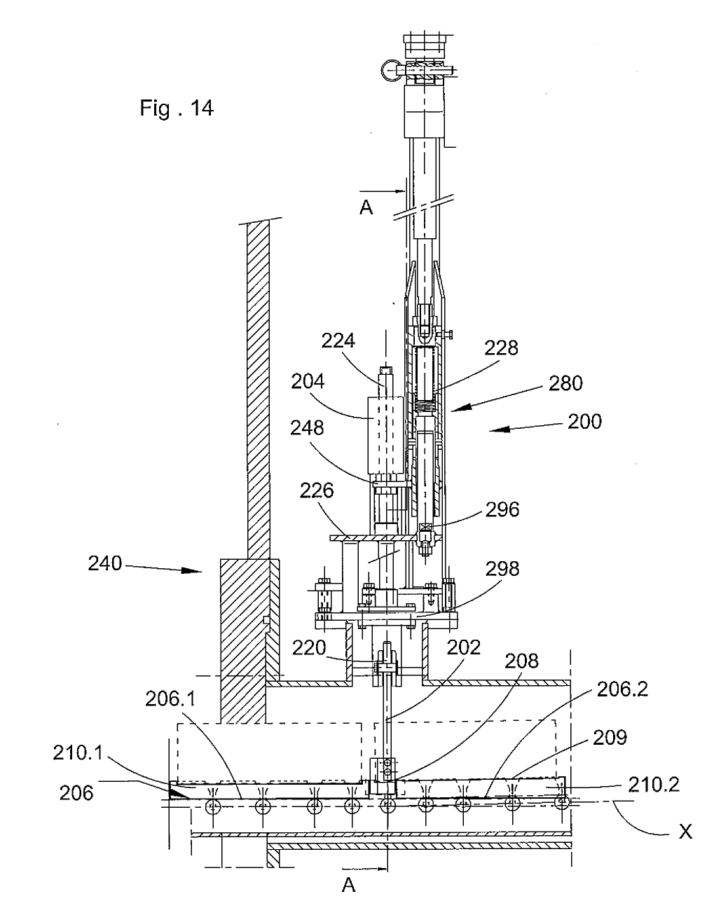

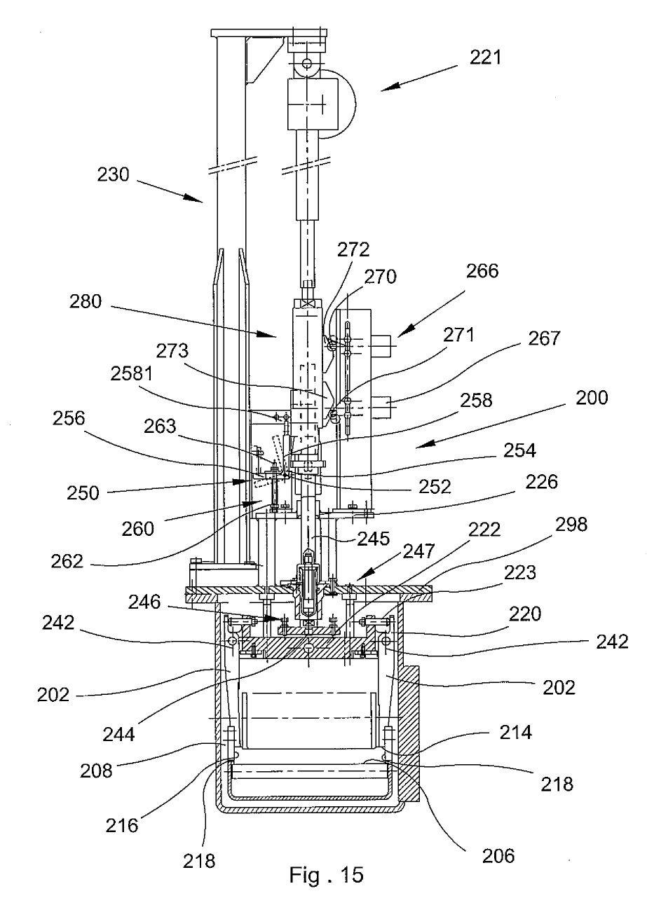

FIGS. 14 to 18 show a third embodiment of a device according to the invention, in which a mass is to be dropped by gravity, wherein the impact causes the breakage of the bond between the sintering shoes.

The device according to the third embodiment, is also positioned at the outlet of the sintering tunnel, as for the previous embodiments.

The device comprises separating means 200 to apply a mechanical impact according to a vertical direction orientated downwards that can break the bond between the sintering shoe 210.2 to be evacuated and the following sintering shoe 210.1.

The separating means 200 comprise at least one arm, advantageously two arms 202, as shown in FIG. 14, to hold the sintering shoe and transmit the mechanical impact caused by the mass 204 dropping.

The arms 202 extend substantially perpendicularly to a sliding surface 206 of the sintering shoes and come into contact by their lower end 208 with the lateral edges 209 of the sintering shoe 210.2.

Advantageously, the ends 208 of the arm 202 comprise an angled portion forming a support surface 214 that may come into contact with the upper surface 209 of the sintering shoe 210.2 and a surface 216 that is substantially perpendicular to the support surface 214 which comes into contact with a lateral surface 218 of the sintering shoe.

The two arms 202 are symmetrical with respect to a median plan containing an axis of movement X of the sintering shoes. Consequently, the sintering shoe 210.2 is held both laterally and according to a horizontal plane.

Each arm 202 may be moved substantially vertically by a movement device 221.

The two arms 202 are fixed by an upper end 242 opposite that designed to come into contact with the sintering shoe, to a cross-bar 222 that may be moved according to a direction that is substantially vertical with respect to a chassis 240, so as to press the arms against the sintering shoe or to move them away.

The arms 202 are mounted so that their end 242 is mobile in rotation on the cross-bar 222; a stop 223 is provided to adjust the distance between the lower end of the arm with respect to the position of the sintering shoes.

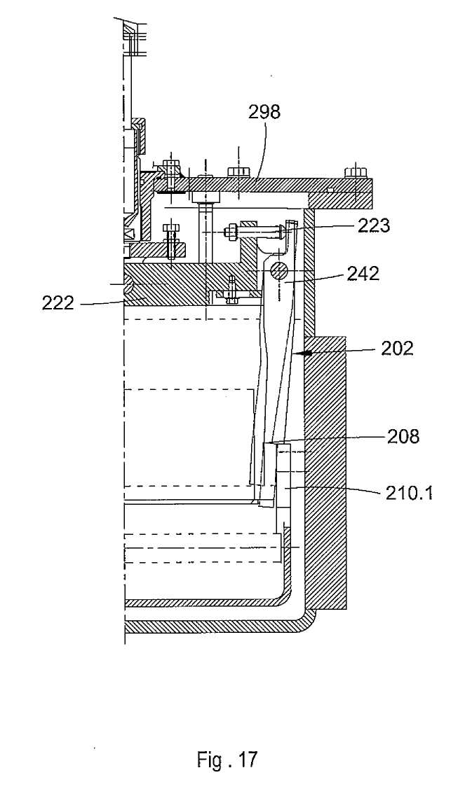

Advantageously, the arms 202 have a rest position, which is to say remote from a sintering shoe, slightly retracted inside the cross-bar, shown in dotted lines in FIG. 17, by means of a spring mounted in reaction between the cross-bar 222 and the stop 223 mounted so that it slides inside the cross-bar 222.

Advantageously, the ends 208 comprise chamfers permitting automatic centering of the cross-bar 222.

The cross-bar 222 is mounted on a movement device 221, articulated to one end of an axis 245 in its central part 244.

Means 246 of limiting the transversal travel of the cross-bar 222 are provided between the cross-bar 222 and the chassis 240, as well as means 247 to prevent its rotation.

In the example shown, the movement device 221 is, for example a linear actuator of the electrical actuator type, suspended from a rod 230.

The actuator 221 is connected to the cross-bar by means of a transmission arm 280 of variable length, which may be seen in detail in FIG. 18. The arm 280 comprises an outer sleeve 282 fixed to one end of the actuator, an inner sleeve 284 that can slide inside the outer sleeve 282, a pin 286 that can slide inside the inner sleeve 284 and elastic means, for example a helical spring 228 mounted inside the outer sleeve 282, between the outer sleeve 282 and the inner sleeve 284.

In the example shown, the pin 286 is mounted so that it slides inside the inner sleeve 284 by means of collars 288.

Pins 290 are provided to limit the axial movement between the inner sleeve 284 and the outer sleeve 282, wherein said pins 290 are fixed inside the outer sleeve 284, and respectively penetrate inside an axial port 292 in the inner sleeve 284.

In the example shown, the spring 228 is in contact with an annular protrusion 294 that is radially inside the inner sleeve 284. It may be provided that the spring 228 is in contact on one longitudinal end of the inner sleeve 284.

The pin 286 is fixed by a lower end 296 to a plate 226 that is immobile with respect to the chassis 240, to form a guide pin for the outside 282 and inside 284 sleeves.

As long as the reaction effort of the sintering shoes on the cross-bar 22 is lower than the load of the spring 228, the outer sleeve 282 and the inner sleeve 284 form a rigid assembly; when the reaction effort becomes greater than the load of the spring, the outer sleeve 282 slides around the inner sleeve 282 causing deformation of the spring and the application of a pre-stress onto the sintering shoe 210.2.

The mass 204 is mounted so that it slides according to a substantially vertical direction around a shaft 224 positioned in parallel to the transmission arm 280. The mass 204 rests on a plate 248 fixed in movement with respect to the axis of the cross-bar 245, substantially orthogonal to the sliding axis of the actuator. Consequently, the mass 204 may be raised along the axis 224 by the rising movement of the outer sleeve 282.

The shaft 224 is mounted so that it slides inside the plate 226 and inside a cover 298 of the sintering tunnel so that it is connected to the cross-bar to which it is fixed axially.

The shaft 224 slides imperviously inside the cover 298 in order to isolate the inside of the tunnel and the outside environment. This seal is obtained, for example, with a quadri-lobe nitrile seal.

The device also comprises a square 250 mounted so that it is mobile in rotation on the chassis 240 around an axis 252 on one corner 254 of the square connecting the legs 256, 258.

Said square is designed to hold, for a short instant, the mass 204 in a suspended position with respect to the plate 248, before it drops under the effect of gravity to strike the plate 248. The mass rests during this instant on an upper end 2581 of the leg 258.

The square 250 may be removed to free the mass 204.

Return means 260 to bring the square back to the rest position are provided, they are formed, in the example shown, by a rod 262 fixed to the chassis 240, of which one end 263 passes through the leg 258 and elastic means, interposed between the plate 226 and the leg 258. Consequently, the leg 258 is always solicited in the direction of the sliding axis 224 of the mass 204.

Sensor means 266, 267 are provided to detect the different positions of the actuator, in particular the sensor 266 detects the rest position of the actuator or “upper position” and the sensor 267 detects the position of the actuator when the arms 202 are in contact with the sintering shoe. In the example shown, the sensors 266, 267 are of the cam type, they comprise an element 270, 271 capable of moving along an associated cam surface 272, 273 comprising a variable slope, wherein said cam surfaces 272, 273 are fixed in movement to the outer sleeve 282. The element 270,271, is in the example shown, a wheel that is mobile in rotation on an arm that is itself mobile. The movement of the arm permits the position of the outer sleeve to be identified.

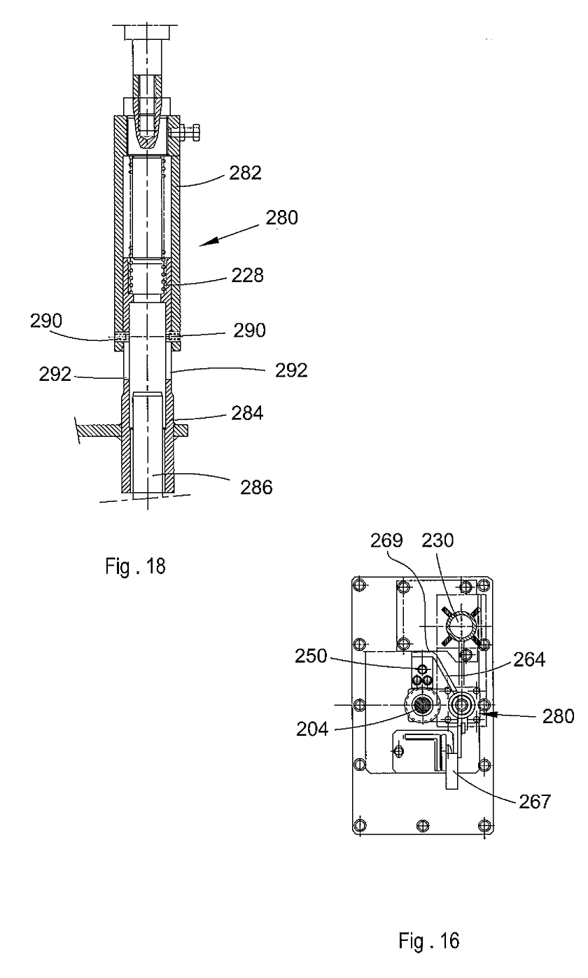

FIG. 16 shows a wire 264 fixed in movement to the wheel of the second sensor 267 extending substantially perpendicularly to the axis of the actuator. This wire 264 permits the square 250 to be removed.

The wire 264 comprises a folded end 269, that can come into contact with the leg 256 of the square, to tilt the square around its axis 252 towards the outside, causing the leg 258 to be moved away from the axis of the mass 204 and it to be freed.

Advantageously, a slope is provided on part of the lower surface 206 on which the sintering shoes move, improving the effect created by the mass 204 dropping. Indeed, the lower surface 206 is not flat and a portion 206.2 on which the sintering shoe 210.2 is located is angled downwards in the direction of movement of the sintering shoes with respect to a portion 206.1 on which the sintering shoe 210.1 is located.

The device also comprises a sintering shoe presence detector (not shown); the detection of a sintering shoe causes the actuation of the separating device.

Advantageously, the device detects a longitudinal end of a sintering shoe downstream of the sintering shoe onto which the arms come into contact, wherein the sintering shoe downstream has already undergone the liberation process as described below, wherein the end of the downstream sintering shoe is advantageously opposite the upstream sintering shoe. The detector is of the encoder type.

We will now describe the operation of such a device.

When the end of the upstream sintering shoe is detected, the movement of the train of sintering shoes is suspended.

The electrical actuator is actuated, causing the movement according to the direction B towards the bottom of the outer sleeve 282 and the inner sleeve 284. Their movement causes the pin 224 to be lowered by means of the transversal square. The pin 224 slides inside the plate 226 and the cover 296. The cross-bar is then lowered, the arms 202 move apart and the lower end 208 of the arms 202 comes into contact with the edges of the sintering shoe 210.2.

When the contact between the arms and the sintering shoe is made, the cross-bar 222 stops moving, however the actuator is still actuated, causing the deformation of the spring 228, wherein the inner sleeve 284 slides inside the outer sleeve 282, applying a predetermined stress to the sintering shoe 210.2.

When the predetermined stress is reached, the actuator stops moving. This stoppage is controlled by the second sensor 267.

When the outside 282 and inside 284 sleeves are lowered, the mass 204 follows their movement over a determined length of travel, then comes into contact with the upper end 2581 of the leg 258 of the square 250.

The outside 282 and inside 284 sleeves continue to descend, and the mass 204 is then suspended on the square 250.

The wheel of the second sensor 267, onto which the wire 264 is fixed, is moved due to the movement of the associated cam surface, wherein the wire 264 comes into contact with the leg 256, causing the square 250 to be tilted towards the outside and the mass 204 to be freed, wherein the latter drops due to gravity onto the plate 248, the impact is transmitted to the axis of the cross-bar 245 and the arms 202 in contact with the sintering shoe, and the arms thus apply a substantially vertical downwards effort to the sintering shoe, which is then moved in the vertical plane with respect to the upstream sintering shoe, causing the bonded link that may exist between the sintering shoes 210.1 and 210.2 to break.

The actuator is then ordered to raise the actuator, raising the sleeves 282, 284, the cross-bar 222, and the mass 204 by means of the square 248. The outer sleeve 282 moves back to its initial position with respect to the inner sleeve 284.

The square 250 moves back to its position during this raising and especially when the leg 256 frees the wire 264.

The feed of the sintering shoes is started again.

Adjustment means are advantageously provided to synchronise the moment when the mass 204 is released and the moment when the predetermined pre-stress is reached.

In the example shown, the surfaces 206.1 and 206.2, on which respectively the sintering shoes 210.1, 210.2 are located, are sloped with respect to one another thus facilitating the breakage of the bond between the sintering shoes 210.1 and 210.2.

It may be provided to maintain the following sintering shoe 210.1 and to apply the impact to this sintering shoe.

The devices according to the three embodiments have a simple and efficient operation, and avoid any damage being caused to the sintering shoes 210.

1. Device comprising a separator of at least two sintering shoes for transporting nuclear fuel pellets capable of moving according to a first axis and of which two end faces are in contact with one another,
wherein said separator is capable of moving at least one of the two sintering shoes, close to said end faces in contact, according to a second vertical axis substantially orthogonal to the first axis.

2. Device according to claim 1, comprising a sensor to detect the presence of sintering shoes, wherein said sensor is capable of detecting the presence of a sintering shoe downstream ready to be evacuated.

3. Device according to claim 1, wherein the separator comprises at least one eccentric that can come into contact with a lower surface of at least one sintering shoe to raise it along the second axis.

4. Device according to claim 3, wherein the contact between the at least one eccentric and the at least one sintering shoe is made at the contact point between the end faces in contact of the two sintering shoes.

5. Device according to claim 1, wherein the contact between the at least one eccentric and the at least one sintering shoe is made on a first sintering shoe of the sintering shoes close to the end faces in contact of the two sintering shoes.

6. Device according to 1, comprising means for limiting the movement of at least one end of a sintering shoe according to the second axis.

7. Device according to claim 6, wherein said end of which the movement is limited is limited on the side opposite the end raised.

8. Device according to claim 6, wherein the means for limiting the movement according to the second axis, simultaneously limit the movement of one end of the first sintering shoe remote from the part raised, and the movement of one end of the other sintering shoe on the side of the end faces in contact with the two sintering shoes.

9. Device according to claim 8, wherein the means for limiting the movement according to the second axis comprise eccentrics for limiting the movement capable of moving close to an upper surface of the sintering shoes to limit how far they are raised with respect to the part that is to be raised.

10. Device according to claim 9, wherein the rotational movements of the eccentrics for limiting the movement and the eccentrics for raising are synchronised so that the eccentrics for limiting the movement and the eccentrics for raising simultaneously move closer to the upper and lower surfaces of the sintering shoes respectively.

11. Device according to claim 10, wherein the eccentrics for raising and limiting the movement are driven by single drive means and are linked in rotation by a chain.

12. Separating device according to claim 1, wherein the separator is capable of exerting an impact on at least one first sintering shoe close to the end faces in contact with the two sintering shoes.

13. Device according to claim 12, wherein the separator comprises arms to hold the first sintering shoe laterally and to transmit the impact to the first sintering shoe, wherein said arms are applied onto the first sintering shoe by an actuator.

14. Device according to claim 13, wherein the impact is applied by a mass which drops due to gravity.

15. Device according to claim 14, wherein the mass is freed when a predetermined stress is applied to the first sintering shoe by the arms designed to be in contact with the sintering shoe.

16. Device according to claim 15, comprising means of suspending the mass and means of removing said suspension means.

17. Device according to claim 16, wherein the removal means are controlled by a second sensor which detects that the predetermined stress has been reached, the second sensor being of the cam type, comprising a cam surface fixed to the outer sleeve and an element that can move along the cam surface.

18. Device according to claim 16, wherein the suspension means comprise a square that is mobile in rotation around a pin that is fixed to a chassis of the separating device, wherein said square comprises a support leg with which the mass comes into contact and an actuation leg to cause the removal of the support leg.

19. Device according to claim 17, wherein the first sensor comprises a wire that may engage with the actuation leg to cause the square to tilt and the support leg to be removed.

20. Device according to claim 13, wherein the arms are fixed by an end opposite to that designed to come into contact with the first sintering shoe, to a cross-bar connected to the actuator by a transmission arm and a pin along which the mass is capable of sliding.

21. Device according to claim 20, wherein the transmission arm comprises an outer sleeve fixed to one end of the actuator, an inner sleeve that can slide inside the outer sleeve, a guiding shaft that can slide inside the inner sleeve and elastic means mounted inside the outer sleeve, between the outer sleeve and the inner sleeve.

22. Device according to claim 20, wherein the mass is in contact in the rest position with a square fixed to the outer sleeve.

23. Device according to claim 13, also comprising a first rest position sensor of the actuator, the rest position sensor being of the cam type, comprising a cam surface fixed to the outer sleeve and an element that can move along the cam surface.

25. Device according to claim 13, wherein the arms comprise at their end that is designed to come into contact with the first sintering shoe, a face forming a vertical stop and a lateral face forming a lateral stop.

26. Device according to claim 25, wherein the ends of the arms are chamfered.

27. Device according to claim 25, wherein the arms have at rest a retracted position so that the distance separating the ends of the arms at rest is smaller than that separating the lateral ends of a sintering shoe.

28. Installation for sintering nuclear fuel pellets comprising a sintering furnace, wherein sintering shoes carrying sintering boats are designed to be moved in a column, and a device comprising a separator of at least two sintering shoes for transporting nuclear fuel pellets capable of moving according to a first axis and of which two end faces are in contact with one another, wherein said separator is capable of moving at least one of the two sintering shoes, close to said end faces in contact, according to a second vertical axis substantially orthogonal to the first axis, wherein said separating device is positioned downstream of the furnace in the direction of movement of the sintering shoes.

29. Manufacturing process for nuclear fuel pellets comprising the following steps:
a) the determination of the presence of at least one sintering shoe,
b) the application of a mechanical stress to at least one sintering shoe in a substantially vertical direction.

30. Process according to claim 29, wherein in step a), the presence of a sintering shoe is determined by the detection of a sintering shoe downstream that is ready to be evacuated.

31. Process according to claim 29, wherein following on from step a), the movement of the sintering shoes is stopped.

32. Process according to claim 29, wherein in step b) the mechanical stress is applied to the two sintering shoes simultaneously.
